(19) United States
(12) Patent Application Publication
(10) Pub. No.: US 2017/0015281 A1
(43) Pub. Date: Jan. 19, 2017

(54) ELEMENT FOR A CONNECTION SYSTEM OF A WINDSCREEN WIPER BRUSH

(71) Applicant: Valeo Systèmes d'Essuyage, Le Mesnil Saint Denis (FR)

(72) Inventors: Guillaume Mouleyre, Saint Genes Champanelle (FR); Vincent Gaucher, Ennezat (FR)

(73) Assignee: Valeo Systèmes d'Essuyage, Le Mesnil Saint Denis (FR)

(21) Appl. No.: 15/208,684

(22) Filed: Jul. 13, 2016

(30) Foreign Application Priority Data
Jul. 17, 2015 (FR) 1556816

(51) Int. Cl. B60S 1/40; B60S 1/38

(52) U.S. Cl. CPC B60S 1/4048; B60S 1/3853; B60S 1/3874; B60S 1/3887; B60S 1/381; B60S 2001/4054

(57) ABSTRACT

Element (26) for a connection system between a windscreen wiper brush and a driving arm of said brush, said element being configured to be fixed selectively to terminal pieces of a plurality of arms, such that the element comprises at least one first bearing surface (48a, 48b) and one first locking means (27) configured to cooperate with a first arm, and it further comprises at least one second bearing surface (60a) and one second locking means (27′) configured to cooperate with a second arm.

### TECHNICAL FIELD

The present invention involves in particular an element for a connection system of a windscreen wiper brush, particularly for an automobile.

### PRIOR ART

An automobile is classically equipped with windscreen wipers to provide for a washing of the windscreen and prevent the driver's view of his or her surroundings from being disturbed. These windscreen wipers generally comprise a driving arm, performing an angular back and forth motion, and elongated brushes, themselves carrying doctor blades made of elastic material. These blades rub against the windscreen and remove the water by taking it outside the field of vision of the driver. The brushes are designed either, in a classical version, as articulated brackets which hold the doctor blade at a plurality of discrete sites allowing it to bend and hug any curvature of the windscreen or, in a more recent version known as “flat blade”, as a semi-rigid assembly which holds the doctor blade over its entire length thanks to one or more bending vertebrae, making it possible to apply the brush to the windscreen without having to use brackets.

In the two solutions, the brush is attached to the driving arm by a connection system comprising a connector and an adapter. The connector is a piece integrated with the brush and generally fixed directly on the doctor blade or on the flat blade, while the adapter is integrated with the arm. The adapter is an intermediate piece enabling the linking and fixation of the connector on the driving arm. It is generally configured to be engaged in a head or terminal piece in the form of a plate and with a U-shaped cross section of the driving arm.

Each of these elements (connector and adapter) has means of articulation configured to cooperate with complementary means of the other element, to define at least one transverse axis of articulation of the elements, which is an axis of articulation of the brush relative to the arm. In the present art, one of the elements, such as the connector, generally has an essentially cylindrical physical axis which defines the axis of articulation and which is received in a seat of complementary shape of the other element.

The adapter generally has a body configured to be engaged in the terminal piece of the arm so that this body extends at least partly between two essentially parallel lateral legs of the terminal piece. The body of the adapter is connected at one end to a fairing or cowling, commonly called a head or cap, against which the free end of the terminal piece is abutted. Finally, the body of the adapter generally comprises an actuation button which is engaged by elastic snapping in an orifice or a notch of the terminal piece when the latter is abutted against the head, in order to lock the adapter in this position with respect to the terminal piece.

An adapter makes it possible to combine a brush with a particular type of terminal piece. In the case of the aforementioned terminal pieces with U-shaped section, for example, several varieties exist. These varieties are very similar in appearance, but differ one from another by the dimensions and especially by their widths or lateral dimensions, the width of a terminal piece being defined by the distance between the lateral legs of the terminal piece and more precisely by the distance between the external surfaces of these lateral legs. They likewise vary in the positions of the orifices or the notches designed to cooperate with the push buttons of the adapter.

In the current art, there are as many varieties of adapter as there are varieties of terminal pieces or ends of the driving arm, which is neither practical nor economical. Thus, there is a real need for a universal adapter able to be mounted on at least two or more terminal pieces of the windscreen wiper arm.

The invention proposes a simple, effective and economical solution.

### EXPLANATION OF THE INVENTION

The invention proposes for this purpose an element between a connection system of a windscreen wiper brush and a driving arm of said brush, said element having a body of general shape extending along a longitudinal axis and being configured to be fixed selectively to a terminal piece of a first or a second arm, and to a terminal piece of a third arm, different from that of the first or the second arm, said element comprising at least one first bearing surface of a portion of said terminal piece of said first or second arm, said element also comprising at least one first locking means, especially a push button, configured to cooperate with said first or second arm. The element further comprises at least one second bearing surface, essentially parallel to said at least one first bearing surface and staggered along the longitudinal axis with respect to said at least one first bearing surface, for at least a portion of said terminal piece of said third arm, said element likewise comprising at least one second locking means, especially a push button, configured to cooperate with said terminal piece of said third arm.

The present invention thus proposes a universal element, of the adapter type, for at least two different driving arms, for example, with U-shaped terminal pieces or ends. The first arm can be of the aforesaid type and have one end designed to bear against the first bearing surface of the element, and at least one orifice or one notch designed to cooperate with the first push button of the element. The second arm comprises a terminal piece, for example one less broad than that of the first arm and designed to bear against the second bearing surface, which is longitudinally staggered, and at least one orifice or one notch designed to cooperate with the first or the second push button of the element.

The element according to the invention can have one or more of the following characteristics, taken in themselves or in combination with each other.
it has a head defining said first bearing surface;
the head is disposed at one longitudinal end of the element;
the body is connected to the head by one of its longitudinal ends;
the head furthermore defines at least one portion of an engagement orifice of a portion of said terminal piece of said first arm. Thus, the universal element according to the invention can moreover be adapted to arms having a tongue able to be positioned in a corresponding engagement orifice of the adapter.

Advantageously, said at least one first surface and said at least one second surface are oriented essentially in the same direction, and in particular they are oriented toward a longitudinal end of the body, opposite the one connected to said head.

According to a series of particular characteristics of the invention, it is provided that the element has a projecting element defining at least said second bearing surface. In this case, it can be provided that
said body comprises two lateral walls which are essentially parallel and at a distance from each other, said at least one projecting element being situated on at least one of these lateral walls,
at least one projecting element is situated on each of said lateral walls,
each projecting element is situated in the vicinity of said head,
each projecting element is retractable and is carried by an elastically deformable tongue of the corresponding lateral wall of said body,
each lateral wall is connected, preferably by an elastically deformable tongue, to a third locking means, especially a push button, these push buttons being able to be connected to longitudinal ends of said lateral walls, opposite said head,
said lateral walls are joined together by a transverse wall,
the transverse wall is connected, preferably by at least one elastically deformable tab, to at least one push button,
the transverse wall is connected to two push buttons, which are essentially aligned one behind the other along a longitudinal axis of the element, and which are preferably situated respectively in the vicinity of the longitudinal ends of the element,
the transverse wall comprises at least a portion of said engagement orifice of said portion of said terminal piece of said first arm,
the element comprises first linking means configured to cooperate with said terminal piece or end of each arm and second linking means configured to cooperate with said brush,
said body comprises means of fixation by elastic snapping, configured to cooperate with said terminal piece or end of each arm,
the push button or each push button is situated in a lumen or slot of the element.

The present invention likewise concerns an assembly comprising an element as described above and at least two driving arms, for a windscreen wiper, in particular that of an automobile, each of said arms comprising a terminal piece having an essentially U-shaped cross section and having two lateral legs defining a lateral dimension of the terminal piece, a first one of the arms having a terminal piece of lateral dimension L1 and a second one of the arms having a terminal piece of lateral dimension L2, less than L1, in which the adapter can be mounted either on one or the other of the terminal pieces, the terminal piece of the first of the arms being designed to bear against the first bearing surface of the element and the terminal piece of the second of the arms being designed to bear against the second projecting bearing surface of the element. The terminal piece of the second arm can then be spaced, in this mounting position, away from the first bearing surface.

The present invention likewise concerns a windscreen wiper brush or arm, characterized in that it comprises or carries an element such as is described above.

### DESCRIPTION OF THE FIGURES

The invention will be better understood and other details, characteristics and advantages of the invention will appear from the perusal of the following description given by way of nonlimiting example, making reference to the enclosed drawings, in which:

FIG. 1 is a schematic perspective view of a windscreen wiper, this windscreen wiper having a windscreen wiper brush, a driving arm for the brush, and a connection system between the brush and the arm,

FIGS. 2 and 3 are schematic perspective views of an element according to the invention for a connection system of a windscreen wiper brush with three driving arms, in a selective manner, and

FIGS. 4 to 6 are schematic perspective views of the element according to FIGS. 2 and 3 mounted on the terminal piece of each of the aforementioned driving arms.

### DETAILED DESCRIPTION

It should be noted that the figures explain the invention in a detailed manner for implementing the invention, said figures of course serving to better define the invention as the case may be.

In the following description, the terms longitudinal or lateral refer to the orientation of the windscreen wiper brush or the driving arm according to the invention. The longitudinal direction corresponds to the principal axis of the brush or the arm in which it extends, while the lateral orientations correspond to concurrent lines, that is, those which cross the longitudinal direction, in particular being perpendicular to the longitudinal axis of the brush or the arm in its plane of rotation. For the longitudinal directions, the terms exterior (or front) or interior (or rear) are understood in relation to the point of fixation of the brush on the arm, the term interior corresponding to the portion where the arm and a half-brush are extending, or in relation to the point of fixation of the arm to the vehicle. Finally, the directions referenced as upper or lower correspond to orientations perpendicular to the plane of rotation of the windscreen wiper brush, the term lower containing the plane of the windscreen.

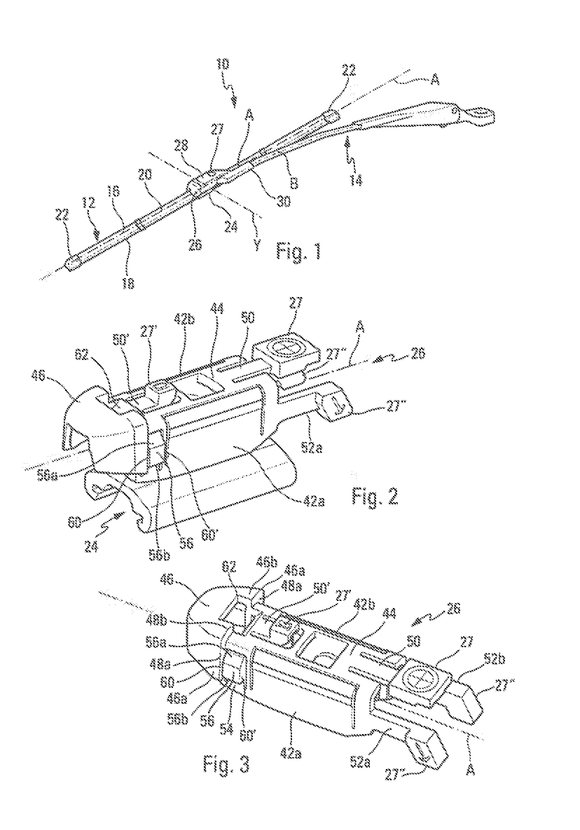

FIG. 1 illustrates a windscreen wiper 10 having in particular a brush 12 and a driving arm 14 for the brush 12.

The brush 12 is preferably of the flat blade type and comprises a longitudinal body 16, a wiper blade 18, generally made of rubber, and at least one vertebra (not visible) which stiffens the blade and enables its application against a windscreen of the vehicle.

The body 16 of the brush 12 can comprise an upper aerodynamic deflector 20 designed to improve the functioning of the wiper system, the purpose of this deflector being to improve the hugging of the windscreen by the brush and thus the aerodynamic performance of the windscreen wiper.

The brush 12 can furthermore comprise end pieces 22 or attachment hooks for the blade 18 and the vertebra on the body 16, these end pieces 22 being situated at each of the longitudinal ends of the body 16.

The brush 12 has essentially at its middle an intermediate connector 24. An adapter 26 integrated with the arm 14 is mounted on the connector 24 so as to maintain a degree of freedom when pivoting about an axis of articulation Y which is a transverse axis essentially perpendicular to the longitudinal axis A of the brush 12. This degree of freedom enables a pivoting of the brush 12 with respect to the arm 14 and thus allows the brush to follow the curvature of the windscreen during its movements. The adapter 26 can be disconnected from the arm 14 by pressing on a locking means, here, a push button 27, carried by the adapter.

The arm 14 is designed to be driven by a motor to follow an angular back and forth movement, making it possible to remove the water and possibly other unwanted elements covering the windscreen. The adapter 26 provides the linkage between the brush 12 and the arm 14 and in particular to a head or terminal piece 28 of the arm which can be formed by a single piece with the arm or be attached and fixed to the latter.

In the example shown, the terminal piece 28 of the arm forms a plate with essentially U-shaped cross section.

The terminal piece 28 has an elongated shape, whose longitudinal axis of extension A is generally essentially parallel to the longitudinal axis or axis of extension of the brush 12. The terminal piece 28 has a portion 30 for linking to the rest of the arm 14, for example, by crimping. This portion 30 has a general elongated shape and extends along an axis B essentially parallel to the axis A and at a distance from this axis, as can be seen in FIG. 1. The portion 30 is connected to a rear or interior end of the rest of the terminal piece 28.

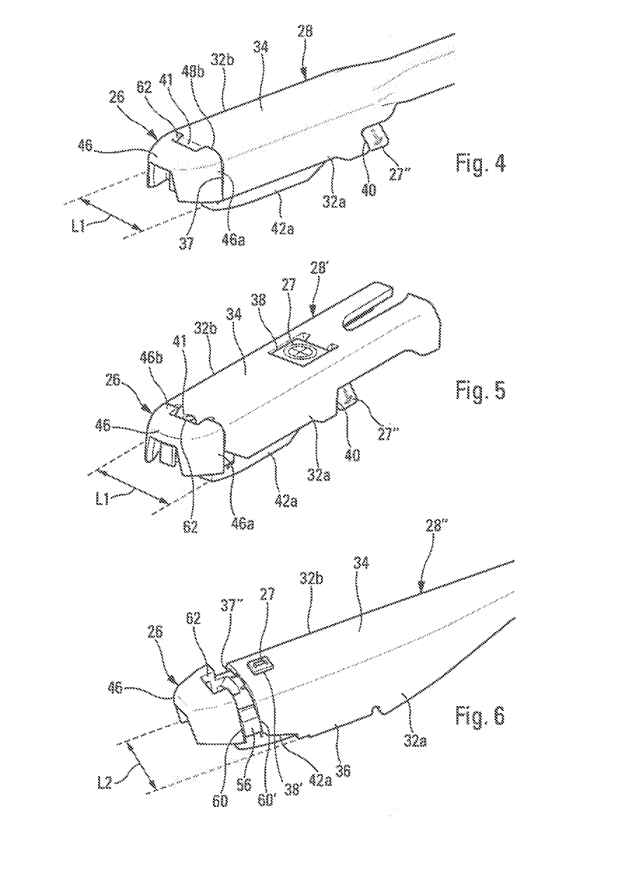

Referring to FIGS. 4 to 6 which show respectively three terminal pieces or ends 28, 28′, 28″ of the driving arm 14, 14′, 14″, each terminal piece comprises two lateral legs 32a, 32b whose upper longitudinal edges are joined to each other by an upper transverse wall 34. The legs 32a, 32b and the wall 34 together bound a space to accommodate the adapter 26.

The legs 32a, 32b can have means 36 such as hooks in the area of their lower longitudinal edges for holding the adapter 26 in said space. The free end 37 of the terminal pieces 28, 28′, 28″ is defined by the edges of the longitudinal end of the legs 32a, 32b and the upper wall 34.

The upper wall 34 can have a through opening 38, 38′ with complementary shape to an upper locking means 27, 27′, especially one of push button type, which is carried by the adapter. In the mounted position, the push button 27 is lodged in this opening 38 and can pass through the latter so as to project out from the upper surface of the wall 34. The mounting of the push button 27 in the opening 38 is done by simple engagement or fitting, preferably by elastic snapping.

The lateral walls 32a, 32b can each have a notch 40 of complementary shape to a third lateral locking means 27, especially one of push button type. In the mounted position, the lateral push buttons 27″ are lodged in these notches 40 and can pass through them so as to project out at the external surfaces of the walls 32a, 32b. The mounting of the push buttons 27″ in the notches 40 is done by simple engagement or fitting, preferably by elastic snapping.

The width is defined as being the lateral dimension of the terminal piece 28, 28′, 28″, measured in a direction essentially perpendicular to the axis A and parallel to the wall 34. Moreover, E is defined as the thickness of each leg 32a, 32b, which amounts to saying the thickness of the plate used to make the terminal piece when the latter is obtained by swaging.

The external width of a terminal piece is measured between the external surfaces of the legs 32a, 32b and the internal width is measured between the internal surfaces of the legs 32a, 32b.

The terminal pieces 28, 28′, 28″ are different Overall, they have the same shape. but differ one from another especially by the dimensions and by the position of their openings 38, 38′ or notches 40. Thus, the first and second terminal pieces 28, 28′ have an internal width L1, and the third terminal piece 28″ has an internal width L2 which is less than the internal width L1.

Furthermore, the opening 38′ of the third terminal piece 28″ is situated in the vicinity of its free end 37″ or exterior end, whereas the opening 38 of the second terminal piece 28′ is more distant from its corresponding free end 37′. Moreover, the opening 38′ of the third terminal piece 28″ has a smaller section than that of the opening 38 of the second terminal piece 28′. The third terminal piece 28″ lacks notches 40 of the aforementioned type, while the first and second terminal pieces 28, 28′ possess such notches 40. The terminal piece 28 has no opening 38.

Finally, the upper walls 34 of the terminal pieces 28, 28′ are prolonged toward the outside so that each one forms a tab 41 with an essentially S-shaped longitudinal section, which is configured to be engaged in an orifice of the adapter 26 according to the invention.

The adapter 26 according to the invention is of the “universal” type and is designed to be mounted either on one or the other of the terminal pieces 28, 28′, 28″.

The adapter 26, better seen in FIGS. 2 and 3, has a general shape extending along the longitudinal axis A. It comprises a body having two lateral walls 42a, 42b essentially parallel to each other and to the longitudinal axis A, and spaced apart from each other. These walls 42a, 42b are joined together at their upper ends by an upper transverse wall 44 essentially perpendicular to the walls 42a, 42b. The walls 42a, 42b, 44 have a shape here which is extending in the longitudinal direction.

The walls 42a, 42b, 44 of the adapter 26 together define a longitudinal space in which a portion of the connector 24 is designed to be installed. The connector 24 carries female means here (not seen) designed to be fitted by elastic snapping in male means of complementary shape projecting from the walls 42a, 42b of the body of the adapter 26.

The body of the adapter 26 is connected at a first of its longitudinal ends to a fairing or cowling, also called a head or cap 46. This head 46 has a lateral dimension greater than that of the body of the adapter and a height also greater than that of the body. The lateral walls 42a, 42b of the body of the adapter are thus recessed or staggered transversely, that is, along the direction of the transverse pivoting axis, with respect to lateral (external) surfaces 46a of the head, and the upper wall 44 of the body of the adapter is recessed or staggered vertically, that is, along a direction perpendicular to the axis of extension A and to the transverse pivoting axis, with respect to an upper (external) surface 46b of the head.

The lateral surfaces 46a of the head 46 are connected to the lateral walls 42a, 42b of the body by rear lateral surfaces 48a, respectively, which extend essentially perpendicular to the longitudinal axis A of the adapter. The upper surface 46c of the head 46 is connected to the upper wall 44 of the body by a rear upper surface 48b which extends likewise essentially perpendicular to the longitudinal axis A.

The rear lateral 48a and upper 48b surfaces of the head 46 form a continuous bearing surface from the free end 37 of the first or second terminal pieces 28, 28′, as can be seen in FIGS. 4 and 5. More precisely, in the mounted position of the adapter in the first or second terminal piece 28 or 28′, the free front edges of the lateral legs 32a, 32b of the terminal piece are designed to bear against the rear lateral surfaces 48a, and the free front edge of the transverse wall 34 of the terminal piece is designed to bear against the surface 48b.

The upper wall 44 of the body of the adapter 26 has longitudinal slots which are parallel to each other and to the longitudinal axis A and spaced apart from each other, so as to define between them longitudinal tongues 50, 50′. Each tongue 50a, 50b is elastically deformable and is connected at its free rear end to an upper push button 27, 27′. In the free and unconstrained state, each tongue 50 is such that the push button 27, 27′ projects above the upper wall 44, that is, toward the exterior of the adapter. The elastic deformations of the tongues take place here in an essentially vertical longitudinal median plane, that is, essentially perpendicular to the upper wall 44.

The adapter 26 is thus outfitted with two upper and independent push buttons 27, 27′. The buttons 27, 27′ are essentially disposed side by side, one behind the other, along the longitudinal axis A. A first tongue 50, here the exterior one, carries at its free end a first 27 push button, essentially at the longitudinal end of the adapter opposite the head 46, and a second tongue 50′, here the interior one, carries at its free end a second 27′ push button, essentially in the vicinity of the head of the adapter.

The first tongue 50 has a long length relative to the length of the second tongue 50′. What is more, the first push button 27 defines an upper surface which is more substantial than the upper surface of the second push button 27′.

The two push buttons 27, 27′ carried by the adapter are advantageously arranged so that their bearing surfaces are essentially aligned and centred. Furthermore, the bearing surfaces can be disposed essentially at the same height, that is, at the same distance from the upper wall of the adapter, or they can be vertically staggered with respect to each other.

In the free and unconstrained state, each tongue 50, 50′ is such that the push button 27, 27′ which it carries projects from the upper wall 44. During the mounting of the adapter 26 in one or the other of the first or second terminal piece 28, 28′, only one of the push buttons is meant to engage by elastic snapping in the corresponding opening 38 or 38′ of the terminal piece, the other push button then being meant to bear against the lower surface of the transverse wall of the terminal piece and be driven downward by elastic deformation.

The lateral walls 42a, 42b of the body are prolonged longitudinally to the rear, opposite the head, by elastically deformable longitudinal tabs 52a, 52b. Each wall 42a, 42b is connected to one tab 52a, 52b, these tabs 52a, 52b being essentially parallel and symmetrical with respect to a median longitudinal plane, essentially vertical, that is, perpendicular to the upper wall 44 of the adapter. The free ends of the tabs 52a, 52b, which are situated on the opposite side from the head, are connected to the lateral push buttons 27″. Each tab 52a, 52b thus carries a third lateral push button 27″. The elastic deformations of the tabs 52a, 52b take place here in an essentially horizontal longitudinal plane, that is, essentially parallel to the upper wall 44. The tabs 52a, 52b can be brought closer together by elastic deformation. The lateral push buttons 27″ are designed to cooperate with the notches 40 of the first or second terminal pieces 28, 28′, in a selective manner.

The lateral walls 42a, 42b of the body of the adapter 26 comprise slots essentially parallel to each other and perpendicular to the longitudinal axis A and spaced apart from each other, so as to define between them essentially vertical tongues 54. Each tongue 54 is elastically deformable and is connected at its free end, here the upper one, to a projecting element 56, such as a gadroon. In the free and unconstrained state, each tongue 54 is such that the element 56 projects from the corresponding wall 42a, 42b. The elastic deformations of the tongues take place here in an essentially vertical transverse plane, that is, essentially perpendicular to the upper wall 44.

The adapter 26 is thus outfitted with two independent projecting lateral elements 56. The elements 56 are disposed on the sides of the adapter 26 and are situated here in the immediate vicinity of the head 46.

Each element 56 has an upper lateral surface 56a and a lower lateral surface 56b. The upper lateral surfaces 56a of the elements 56 converge on each other in the upward direction, and their lower lateral surfaces 56b are essentially parallel.

Moreover, each element 56 has an exterior surface 60 and an interior surface 60′, essentially parallel to each other and perpendicular to the longitudinal axis A. The exterior surfaces 60 of the elements 56 are coplanar and disposed opposite the lateral bearing surfaces 48a of the head 46, being separated from each other by the aforementioned slots of the lateral walls 42a, 42b. The interior surfaces 60′ of the elements 56 are coplanar and form the second bearing surface of the free end 37″ of the third terminal piece 28″, as is seen in FIG. 6. More precisely, in the mounted position of the adapter in the third terminal piece 28″, the front free edges of the lateral legs 32a, 32b of the third terminal piece 28″ are meant to bear against the interior surfaces 60′ of the projecting elements 56. The interior surface 60′ of each of the elements 56 can have a transverse dimension or width close to the thickness E of a leg of the third terminal piece 28″.

The lower lateral surfaces 56b of the elements 56 are essentially parallel to the lateral (external) surfaces 46a of the head 46 and are recessed or staggered with respect to the latter.

The lower lateral surfaces 56b of the elements 56 are spaced apart from each other by a transverse distance essentially equal to the external width L2 of the transverse piece 28″. Thus, these surfaces 56b are aligned with the external surfaces of the legs 32a, 32b of the third terminal piece 28″, as is seen in FIG. 6. Moreover, the external surfaces of the lateral walls 42a, 42b of the body of the adapter can be spaced apart from each other by a transverse distance essentially equal to the internal width of the third terminal piece 28″. Thus, the third terminal piece 28″ is wedged in the transverse direction by cooperation of its legs with the lateral walls of the body of the adapter.

As indicated above, the first and second terminal pieces 28, 28′ have a larger width than that of the third terminal piece 28″. In the mounted position on the adapter 26, the legs of these first or second terminal pieces bear against the elements 56 and force them transversely toward each other. It is the cooperation of the elements 56 with the first or the second terminal piece 28, 28′ which allows it to be wedged in the transverse direction.

In the example shown, the adapter 26 moreover comprises an upper engagement orifice 62 for tabs 41 of the first or second terminal pieces 28, 28′ (FIGS. 4 and 5). This orifice 62 is formed here in part in the head 46, at its rear end, and in part in the upper wall 44, at its front end. The orifice 62 has a general square or rectangular shape.

The mounting of the adapter 26 according to the invention on each of the terminal pieces 28, 28′, 28″ shall now be described.

Referring to FIG. 4, the adapter 26 is engaged in the first terminal piece 28 by first of all tilting the axis of the adapter relative to that A of the first terminal piece 28, then engaging the tab 41 of the terminal piece in the orifice 62 of the adapter. During this engagement, the legs of the first terminal piece begin to slide over the upper surfaces 56a of the elements 56, then over the lower surfaces 56b, which causes the elements 56 to approach each other. Moreover, the front end edge of the upper wall of the first terminal piece comes to bear against the surface 48b of the head 46 of the adapter. The rear end of the adapter is then moved closer to the first terminal piece until the lateral push buttons 27″ engage by elastic snapping in the notches 40 of the first terminal piece 28. The front end edges of the lateral legs 32a, 32b of the first terminal piece come to bear against the lateral bearing surfaces 48a of the head 46 forming the first bearing surface of the adapter. The axes of extension of the adapter and of the first terminal piece 28 are then essentially parallel.

Referring to FIG. 5, the adapter 26 is engaged in the second terminal piece 28′ by first of all tilting the axis of extension of the adapter relative to that of the second terminal piece 28′, then engaging the tab 41 of the second terminal piece in the orifice 62 of the adapter. During this engagement, the legs of the second terminal piece begin to slide over the upper surfaces 56a of the elements 56, then over the lower surfaces 56b, causing the projecting elements 56 to come closer together. Moreover, the front end edge of the upper wall of the second terminal piece comes to bear against the upper bearing surface 48b of the head 46 forming part of the first bearing surface. The rear end of the adapter is then brought closer to the second terminal piece until the lateral push buttons 27″ engage by elastic snapping in the notches 40 of the second terminal piece 28′, and the first upper push button 27 engages by elastic snapping in the opening 38 of the second terminal piece 28′. The front end edges of the lateral legs 32a, 32b of the second terminal piece come to bear against the lateral bearing surfaces 48a of the head 46 forming part of the first bearing surface. The axes of extension of the adapter and of the second terminal piece 28′ are then essentially parallel.

Finally, referring to FIG. 6, the adapter 26 is engaged in the third terminal piece 28″ by first of all tilting the axis of the adapter relative to that A of the third terminal piece 28″, then engaging the body of the adapter between the legs of the third terminal piece. During this engagement, the legs of the third terminal piece cooperate by sliding with the lateral walls 32a, 32b of the body and come to bear against the interior surfaces 60′ of the elements 56 forming the second bearing surface of the adapter. The rear end of the adapter is then brought closer to the third terminal piece until the second upper push button 27′ engages by elastic snapping in the opening 38′ of the third terminal piece 28″. The axes of the adapter and of the third terminal piece 28″ are then essentially parallel. As is seen in FIG. 6, the free end 37″ of the third terminal piece 28″ bears against the second bearing surface, carried here by the projecting elements 56, and this free end is spaced apart from the head 46 by a distance corresponding to the width or longitudinal dimension (along the axis A) of the elements 56. The free end of the third terminal piece 28″ thus does not bear against the first bearing surface, carried here by the head 46 of the adapter 26.

1. An element for a connection system between a windscreen wiper brush and a driving arm of said brush, said element comprising:
a body of general shape extending along a longitudinal axis and being configured to be fixed selectively to a terminal piece of at least a first or a second arm, and to a terminal piece of a third arm;
at least one first bearing surface of a portion of the terminal piece of said at least first or second arm;
at least one first locking means configured to cooperate with said terminal piece of said first or second arm;
at least one second bearing surface, essentially parallel to said at least one first bearing surface and staggered along the longitudinal axis with respect to said at least one first bearing surface, for at least a portion of the terminal piece of said third arm;
at least one second locking means configured to cooperate with said terminal piece of said third arm.

2. The element according to claim 1, further comprising a head defining said first bearing surface.

3. The element according to claim 2, wherein said head is disposed at one longitudinal end of the element.

4. The element according to claim 3, wherein said body is connected to said head by one of its longitudinal ends.

5. The element according to claim 2, wherein said at least one first surface and said at least one second surface are oriented essentially in the same direction.

6. The element according to claim 5, wherein said at least one first surface and said at least one second surface are oriented toward a longitudinal end of the body, opposite the one connected to said head.

7. The element according to claim 2, further comprising a projecting element defining at least said second bearing surface.

8. The element according to claim 7, wherein said body comprises two lateral walls which are essentially parallel and at a distance from each other, said at least one projecting element being situated on at least one of these lateral walls.

9. The element according to claim 8, wherein at least one projecting element is situated on each of said lateral walls.

10. The element according to claim 9, wherein each projecting element is situated in the vicinity of said head.

11. The element according to claim 9, wherein each projecting element is retractable and is carried by an elastically deformable tongue of the corresponding lateral wall of said body.

12. The element according to claim 9, wherein each lateral wall is connected by an elastically deformable tab to a third locking means.

13. The element according to claim 12, wherein the third locking means are connected to longitudinal ends of said lateral walls, opposite said head.

14. The element according to claim 9, wherein said lateral walls are joined together by a transverse wall.

15. The element according to claim 14, wherein the transverse wall is connected by at least one elastically deformable tongue to at least the first or the second locking means.

16. The element according to claim 15, wherein the transverse wall is connected to the first and to the second locking means.

17. The element according to claim 16, wherein the two locking means are essentially aligned one behind the other along the longitudinal axis of the element.

18. The element according to claim 16, wherein the two locking means are arranged such that the first locking means is situated in the vicinity of one longitudinal end of the element and the second locking means is situated in the vicinity of the opposite longitudinal end of the element.

19. The element according to claim 14, further comprising an engagement orifice of a portion of said terminal piece of said first or second arm.

20. The element according to the previous claim 19, wherein the head carries a portion of said engagement orifice.

21. The element according to claim 19 wherein the transverse wall comprises at least a portion of said engagement orifice.

22. The element according to claim 1, wherein at least one of the first locking means, the second locking means and the third locking means is a push button.

23. A windscreen wiper brush or arm, comprising or carrying an element according to claim 1.
